(19) United States
(12) Patent Application Publication
(10) Pub. No.: US 2015/0375486 A1
(43) Pub. Date: Dec. 31, 2015

(54) METHOD AND TOOL FOR PROCESSING MATERIALS

(71) Applicant: LISEC AUSTRIA GMBH, Seitenstetten (AT)

(72) Inventors: Leopold MADER, Neuhofen/Ybbs (AT); Gunther SCHOLLHAMMER, Munchen (DE)

(73) Assignee: LISEC AUSTRIA GMBH, Seitenstetten (AT)

(21) Appl. No.: 14/766,000

(22) PCT Filed: Sep. 29, 2014
(86) PCT No.: PCT/AT2014/000176

§ 371 Date: Aug. 5, 2015

(30) Foreign Application Priority Data
Sep. 27, 2013 (AT) A 751/2013
Oct. 31, 2013 (AT) A 837/2013

(51) Int. Cl. B32B 37/00

(52) U.S. Cl. CPC B32B 37/0046

(57) ABSTRACT

The tool (1, 12, 30, 33, 55, 63) which is used for processing a sticky pasty material (11, 62), consists of a meltable or sublimatable material, in particular ice, at least in the regions which come into contact with the material (11, 62) to be processed.

The invention relates to a method and a tool for processing sticky, in particular deformable, material.

When processing sticky material, problems frequently arise since the material that is to be processed exerts its adhesive action not only according to requirements but it also adheres to tools that are used in processing it.

The lodgment of sticky material on the tools used in its processing is undesirable, since the tools become soiled, and soiled tools can wind up soiling other objects, such as, for example, a workpiece that is to be processed. This is the case in particular when the tools used for processing sticky material are spatulas, scrapers, smoothing devices, seating and supporting devices, or shuttering elements.

Soiling by hardening (chemically binding or solidifying during cooling) pasty, sticky materials tends to accumulate, i.e., the soiling gradually builds up when such materials are processed.

The adhesion of sticky material to the tools that are used in its processing is especially problematic when the processing of the sticky material is carried out in an automated manner, since then a monitoring of the soiling is not easily possible.

Proposals for overcoming the problem of the undesired adhesion of a compound that is to be processed on a tool that is used for its processing consist in, for example,

(i) Manufacturing at least the parts of the tool that come into contact with the material, which tool consists of a working material to which the material has little or no tendency to adhere (“anti-adhesive effect”),

(ii) Coating at least the parts of the tool that come into contact with the material with a working material to which the material has little or no tendency to adhere, and

(iii) Providing a separating agent, which rests as a liquid film or powder layer between the material and the tool.

As a separating agent, for example, oils, talc or water are used.

In many cases, a tool for processing sticky material is unsuitable as soon as sticky material adheres to the tool.

The problem described arises during, for example, the production of insulating glass, in particular during sealing of insulating glass blanks, when the sticky sealing compound according to requirements is introduced into the edge joint of the insulating glass blank. In this case, problems arise with the sticky sealing compound, since the latter adheres not only to the sealing nozzles, in particular their small nozzle plates, and contamination builds up, but also on small scraping plates used during smoothing of the sealing compound (cf. DE 34 08 688 A) and smoothing rollers (cf. AT 395 710 B) as well as on conveying systems for sealed insulating glass blanks (cf. AT 384 596 B).

For example, it is impossible to ensure smooth and clean application by means of a spatula of a pasty, sticky compound, such as, for example, sealing compound, introduced into an edge joint of an insulating glass blank, when the pasty, sticky compound adheres to the spatula.

Devices for filling edge joints of insulating glass blanks (sealing machines) are known from, e.g., DE 28 45 475 A, DE 28 16 437 C, DE 28 46 785 A, DE 28 34 902 A, AT 409 859 B, and DD 158 766 C.

Devices with angled spatulas, with which points of contact in the seal that lie in the area of a corner of an insulating glass blank can be completely closed without air pockets developing in the interior of the sealing compound, are known from DE 34 08 688 A, AT 13 328 U and US 8,435,367 B.

As sealing compound, for example, hot-processed polyisobutylene-based thermoplastic material or binding (reactive) material based on silicone, polysulfide or polyurethane can be used.

The object of the invention is to improve a method for processing sticky (pasty) material and a tool that can be used for this purpose in such a way that the indicated problems are avoided or at least reduced.

According to the invention, this is achieved with a method that has the features of the independent claim that is aimed at the method.

Insofar as the tool according to the invention is concerned, the object is achieved with a tool that has the features of the independent claim that is aimed at the tool.

Preferred and advantageous further developments of the method according to the invention and the tool according to the invention are subjects of the subclaims.

In an exemplary embodiment, the method according to the invention is characterized in that the working material of the tool melts.

In an exemplary embodiment, the method according to the invention is characterized in that the working material of the tool is sublimated.

In an exemplary embodiment, the method according to the invention is characterized in that the effective surface is produced by a coating being produced in the area of the tool, which comes into contact with the working material that is to be processed.

In an exemplary embodiment, the method according to the invention is characterized in that the coating is produced by the working material that forms the coating being applied on a cooled portion of the tool.

In an exemplary embodiment, the method according to the invention is characterized in that the coating is produced by the tool being cooled below the melting point and being immersed in the (melting) liquid working material.

In an exemplary embodiment, the method according to the invention is characterized in that the coating is produced by the tool being cooled and being flushed and/or sprayed and/or drizzled with the working material.

In an exemplary embodiment, the method according to the invention is characterized in that the cooled tool is brought into contact with the working material in the form of an aerosol that forms the coating.

In an exemplary embodiment, the method according to the invention is characterized in that the coating is produced by a cooled portion of the tool being brought into contact with vapor, in particular water vapor.

In an exemplary embodiment, the method according to the invention is characterized in that the tool is cooled by a cooling medium being brought into contact with the tool.

In an exemplary embodiment, the method according to the invention is characterized in that the tool is cooled by at least one Peltier element being activated in the latter.

In an exemplary embodiment, the method according to the invention is characterized in that a tool is used that consists of a working material with high heat conductivity, such as metal, at least in its portion that holds the coating.

In an exemplary embodiment, the method according to the invention is characterized in that the tool is used for deforming pasty, in particular sticky, working material.

In an exemplary embodiment, the method according to the invention is characterized in that sealing compound that is introduced into the edge joint of an insulating glass blank is deformed.

In an exemplary embodiment, the method according to the invention is characterized in that a strand that consists of deformable working material that is applied on a plate-shaped object is deformed.

In an exemplary embodiment, the method according to the invention is characterized in that a strand that consists of deformable working material, which is applied on the edge of a component that consists of one layer or of several layers, is deformed.

In an exemplary embodiment, the method according to the invention is characterized in that a tool is used of which the working material that forms the effective surface is frozen water.

In an exemplary embodiment, the method according to the invention is characterized in that a tool is used of which the working material that forms the effective surface is a mixture of meltable substances.

In an exemplary embodiment, the method according to the invention is characterized in that a tool is used that is designed as a spatula tool, a scraping tool, a smoothing tool, a smoothing roller, a sealing nozzle, a conveying element or a shuttering element.

In an exemplary embodiment, the method according to the invention is characterized in that a tool is used of which the working material that forms the effective surface of the tool is renewed continuously.

In an exemplary embodiment, the method according to the invention is characterized in that a tool is used of which the working material that forms the effective surface is renewed by the working material that forms the effective surface being cooled continuously until solidification takes place.

In an exemplary embodiment, the method according to the invention is characterized in that the tool is produced by cooled, solidified working material being squeezed out of a tube by liquid working material flowing up behind it.

In an exemplary embodiment, the method according to the invention is characterized in that heat is removed from the tube by a cooling coil.

In an exemplary embodiment, the method according to the invention is characterized in that working material that melts off from the effective surface of the tool is collected in liquid form and optionally used again.

In an exemplary embodiment, the method according to the invention is characterized in that a tool with two effective surfaces that are at an angle to one another is used.

In an exemplary embodiment, the method according to the invention is characterized in that the angle between the effective surfaces of the tool can be changed.

In an exemplary embodiment, the method according to the invention is characterized in that a tool is used of which effective surfaces are the walls of a groove.

In an exemplary embodiment, the method according to the invention is characterized in that a tool that is designed as a sealing nozzle with a small sealing plate is used and in that the surface of the small nozzle plate that faces the edge joint is covered with the coating, in particular a coating that is made of ice, as an effective surface.

In an exemplary embodiment, the method according to the invention is characterized in that the coating is produced in the form of ice by the cooled tool being exposed to atmospheric humidity after it has been cooled below the freezing point.

In an exemplary embodiment, the method according to the invention is characterized in that the coating in the form of ice is smoothed by preferably surface melting, preferably by a hot-air blower or a moved part.

In an exemplary embodiment, the method according to the invention is characterized in that the tool is cleaned by being heated in order to bring about melting/sublimation of the working material.

In an exemplary embodiment, the tool according to the invention is distinguished in that at least the effective surface of the tool that faces the material that is to be processed consists of a working material that under the conditions prevailing during the processing, in particular the temperature, switches from its first solid aggregate state into another aggregate state.

In an exemplary embodiment, the tool according to the invention is distinguished in that the working material of the tool has a melting point that is less than or equal to the temperature that prevails during the processing.

In an exemplary embodiment, the tool according to the invention is distinguished in that the working material is sublimated at the temperature that prevails during the processing.

In an exemplary embodiment, the tool according to the invention is distinguished in that it is selected from the group that comprises a conveying element, an angled spatula, a scraping tool, a smoothing tool, a smoothing roller, and a sealing nozzle.

The invention is explained below by way of example based on a(n) (automated) method for filling the edge joints of insulating glass blanks with sealing compound (“sealing”).

The invention can also be applied in the case of tools that are used during the processing of sticky material by hand, such as, for example, during smoothing of sealant (sealing compound) introduced into joints (edge joints of insulating glass blanks)

According to the invention, in particular the anti-adhesive properties of melting working materials and the melts in this case forming on the surface of tools that consist of melting substances or of coatings of the effective surfaces of tools are used.

Within the framework of the invention, frozen water (“ice”) is preferably taken into consideration as a meltable working material.

When the material that is to be processed or objects that come into contact with the material that is to be processed are not compatible with water, or the melting point of water lies outside the temperature range that is possible during processing of the material, a different meltable substance instead of water can be used. For example, fats can be used as meltable working materials.

As meltable working materials, meltable mixtures of various working materials are also taken into consideration within the framework of the invention.

It is especially advantageous when the meltable working material (or at least one component of a mixture) undergoes a desired chemical reaction with the sticky material. This is the case, for example, when the material involves an adhesive and the meltable working material (or at least one component of a mixture that forms the working material) is used as a binding accelerator and/or as an adhesion promoter.

When the material that is to be processed is, for example, an adhesive that binds with the uptake of water, water, in addition to the purpose according to the invention, can also be used as a reagent that promotes binding.

The term “melting” as a possible change of the first solid aggregate state of the working material is not viewed in the strictly thermodynamic sense as a designation for a first-order phase conversion: “melting” is also defined here as the softening of wax and the non-congruent melting of multi-substance systems.

The anti-adhesive properties of melting working materials are occasionally provided just from the fact that a film forms from melts on the surface of an element that consists of the above.

The melt is used as a separating agent.

One advantage of a melt that acts as a separating agent and that forms on the surface of the tool consists in that the separating agent is formed in situ and must not be fed in separately.

Another advantage of the use, according to the invention, of tools that consist of melting working material or tools with a coating that consists of a melting working material consists in that the separating agent film can be constantly renewed and contaminations of the same as well as contaminations of the tool can be removed simply with excess melt.

Independently of the function of the melt as a separating agent, the adhesion between the tool that is used according to the invention and the material that is to be processed is reduced, since the surface layer of the tool is renewed constantly by ablation of the tool or its coating.

In this sense, a tool that consists of sublimating working material or with a coating that consists of such a working material, such as, for example, dry ice, can also have the anti-adhesive properties that are desired according to the invention.

In particular, however, the use of tools, which consist at least partially of ice as a melting material, as spatula, scraping and smoothing tools, supporting and seating devices, as well as shuttering elements for the processing of sticky, pasty compounds, is taken into consideration.

The tool can consist of a solid ice element, or it is provided with a coating of ice, for example coated, in the area of the surface of the tool, which enters into contact (“effective surface”) with the compound that is to be processed.

When a tool is used of which the effective surface has a coating that consists of the working material that is proposed according to the invention, the coating can be produced by the cooled tool being brought into contact with the working material that forms the coating (in liquid or vapor form).

For example, it may suffice to expose the cooled tool to moist air so that water precipitates on the tool and forms an ice layer. This layer can, if it is rough, be smoothed by surface melting.

With the invention, it is also possible to clean off any residues of sticky material from the tool by melting (off) of the tool or at least its coating.

Embodiments of the invention are explained below with reference to the drawings, in which embodiments are diagrammatically depicted. Here:

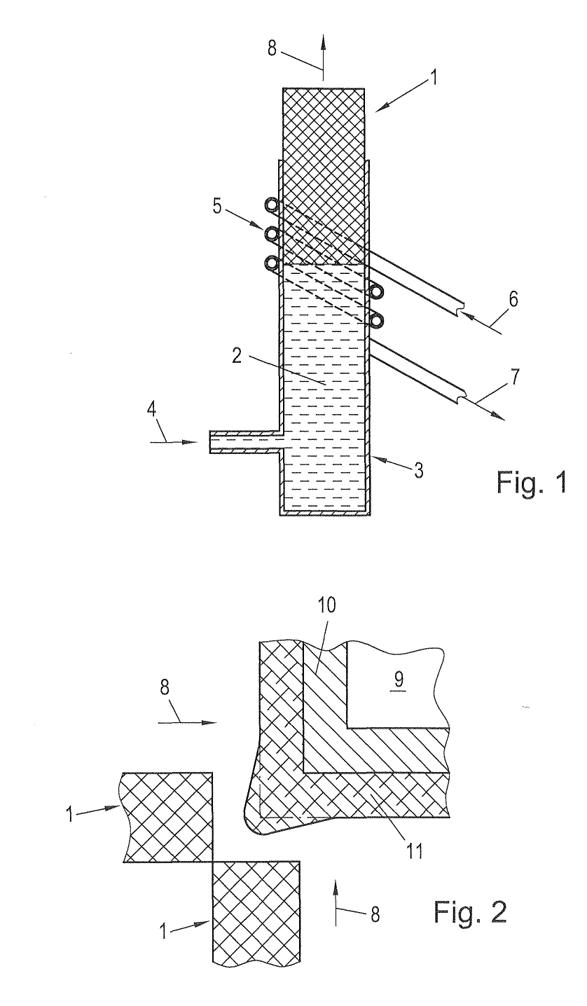

FIG. 1 shows a tool in the form of a rod that consists of a solid ice element and a device for producing the tool,

FIG. 2 shows the deforming of sealing compound, introduced into an edge joint of an insulating glass blank, in the corner area using a tool that is made of ice,

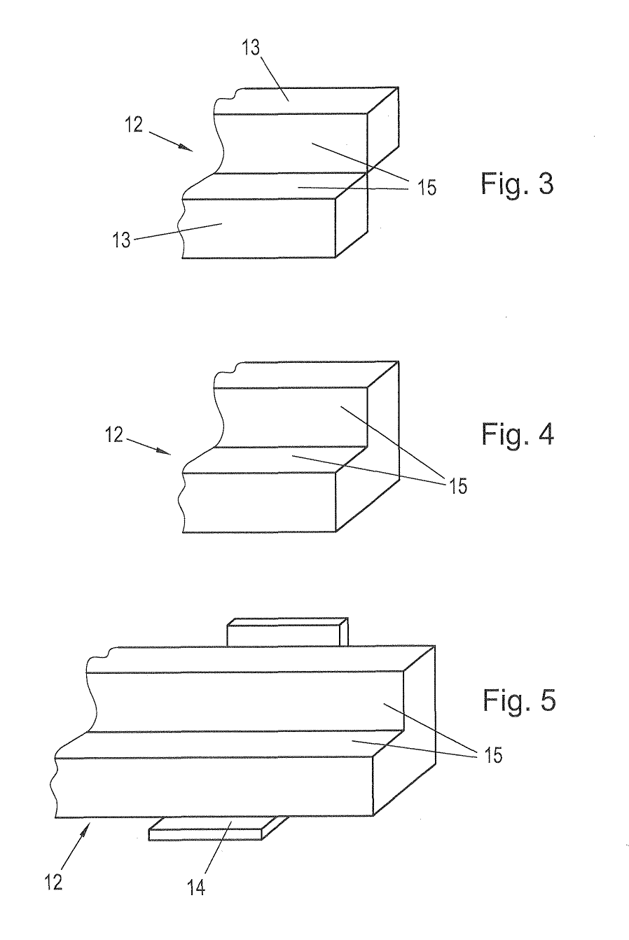

FIG. 3 shows the tool of FIG. 2 in oblique view,

FIG. 4 shows a modified embodiment of a tool with an L-shaped cross-sectional shape,

FIG. 5 shows the tool of FIG. 4 with a support,

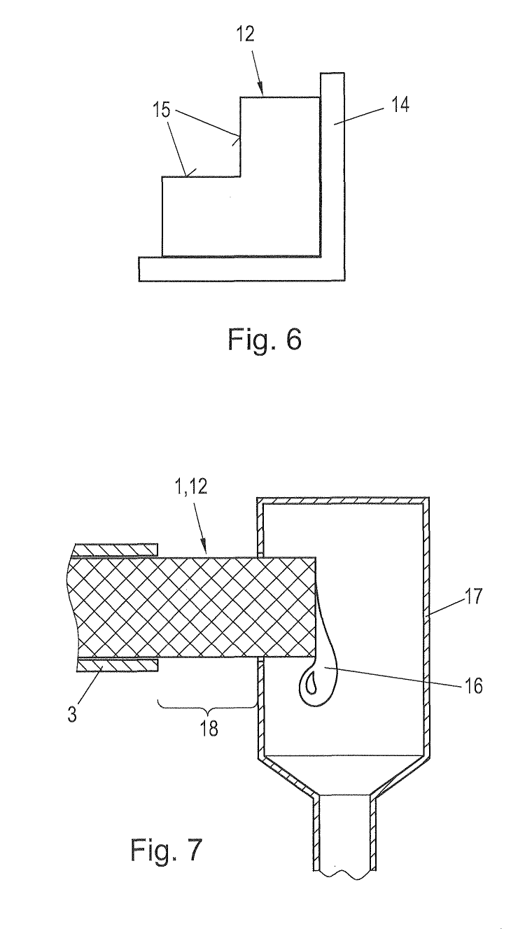

FIG. 6 shows the tool of FIG. 5 in a side view,

FIG. 7 shows a rod-shaped tool when it is in use,

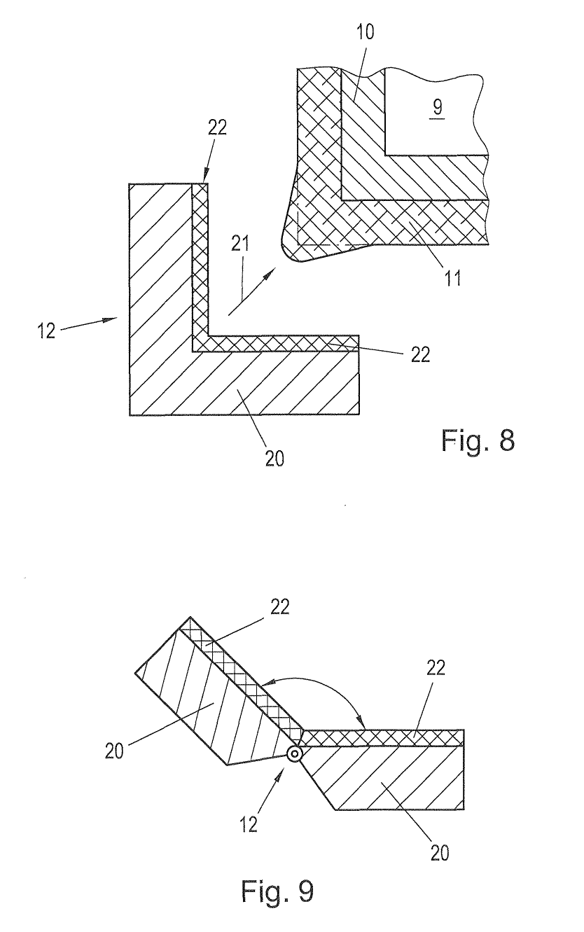

FIG. 8 shows a tool for deforming the corner area of the sealing compound that is introduced into an edge joint of an insulating glass blank,

FIG. 9 shows a modified embodiment of the tool of FIG. 8,

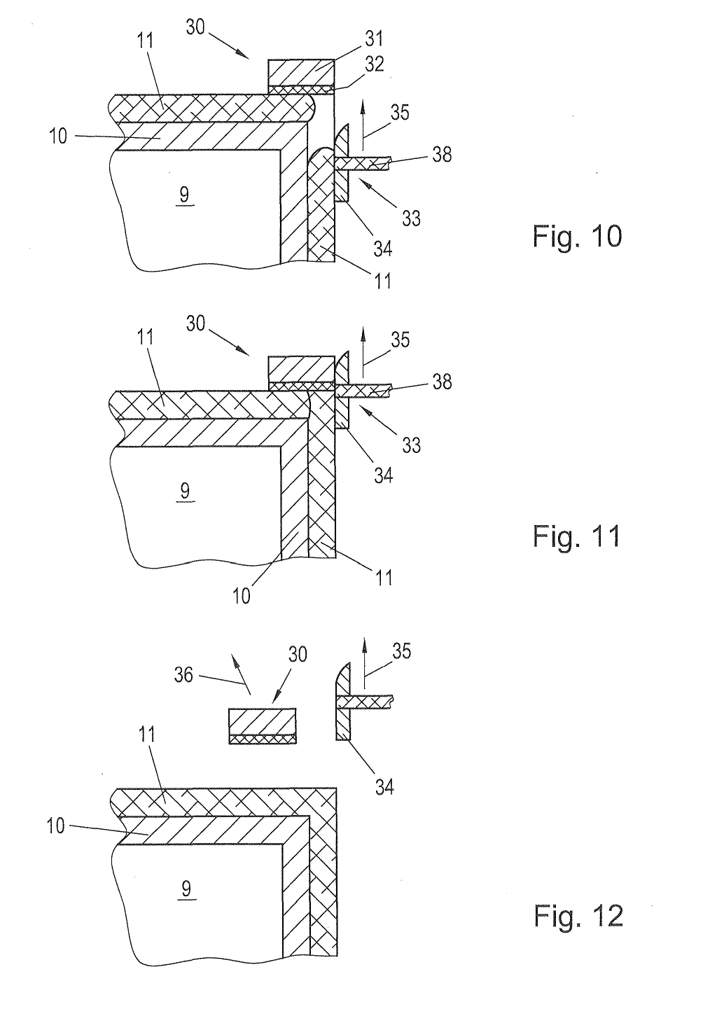

FIGS. 10 to 12 show a tool in the form of a cornered spatula,

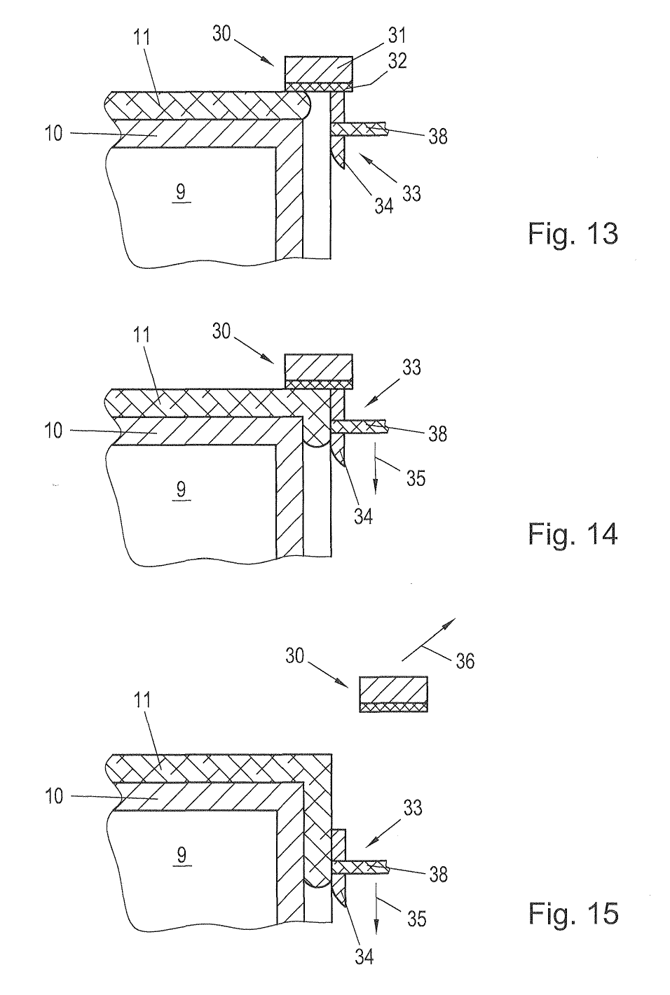

FIGS. 13 to 15 show another application of a tool in the form of a cornered spatula,

FIG. 16 shows a tool in the form of a sealing nozzle with small nozzle plates,

FIG. 17 shows a sealing nozzle with a layer of ice on the small nozzle plates,

FIG. 18 shows the cooling of a tool with a built-in cooling coil,

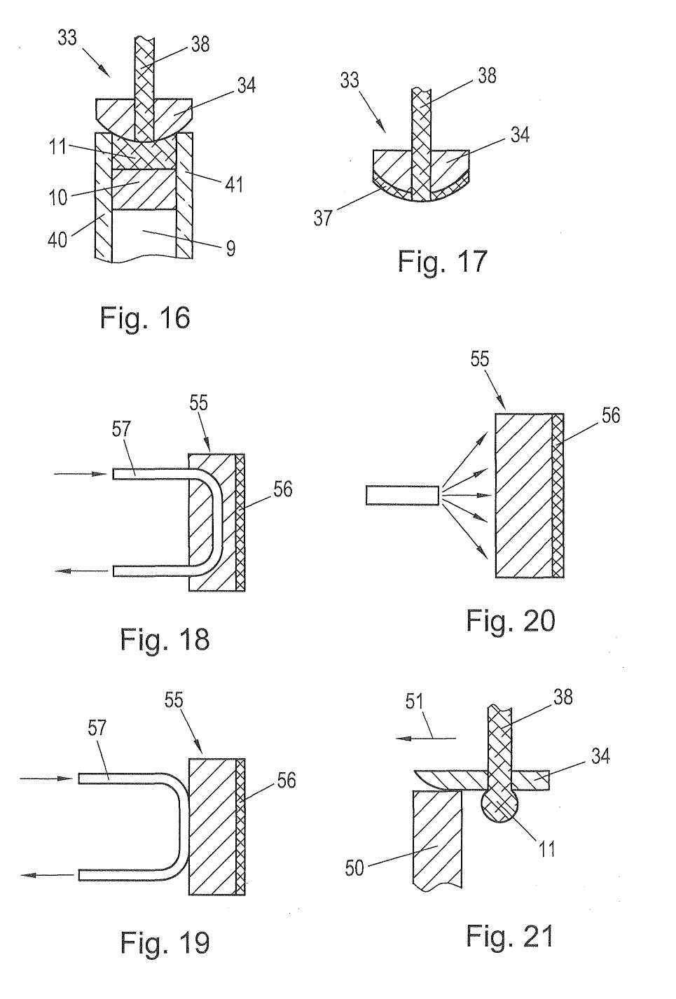

FIG. 19 shows the cooling of a tool with a cooling coil that is arranged outside,

FIG. 20 shows the cooling of a tool by blowing a stream of cold gas on said tool,

FIG. 21 shows the scraping of the small nozzle plate of a sealing nozzle on a scraper,

FIG. 22 shows in cross-section a material bead that is applied on a substrate and a tool for deforming the material bead,

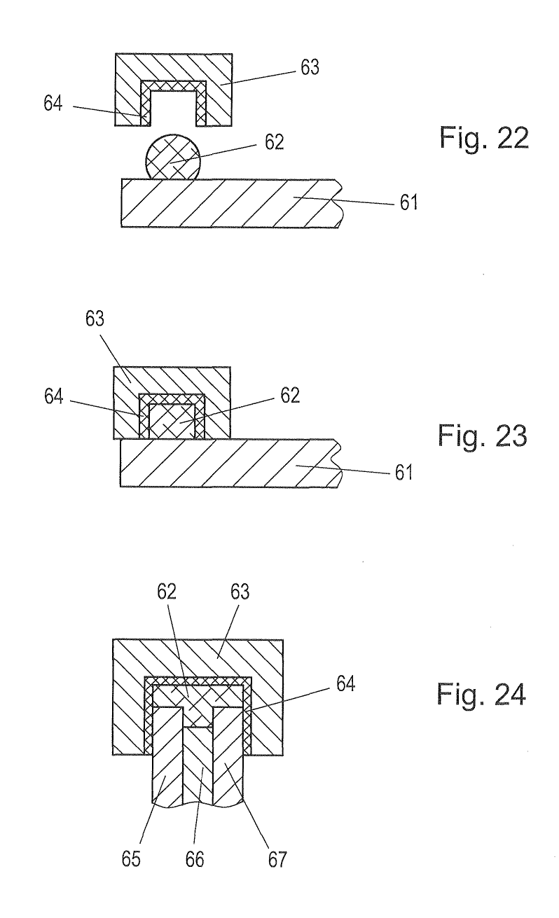

FIG. 23 shows the tool of FIG. 22 during deforming, and

FIG. 24 shows a tool for shaping an edge seal of a multi-layer workpiece.

A tool 1 that consists of a solid ice element can be produced, for example, in the form of a growing rod, as is depicted diagrammatically in FIG. 1: Liquid water 2 is introduced through an intake 4 into a tube 3 that is open on one side. The water 2 that fills the tube 3 is cooled in an area of the tube 3 by means of a cooling coil 5, so that water 2 in the interior of the tube 3 solidifies into ice.

The rod-shaped ice element that forms the tool 1 is pushed out from the tube 3 by liquid water 2 flowing via the intake 4 into the interior of the tube 3 in the direction of the arrow 8.

The forward motion of the tool 1 in the form of a rod that is made of ice can be done either by the forward motion under the action of the water 2 that flows back into the tube 3 or by means that are provided for this purpose, for example driven gears that grasp the tool. Also, a combination of both types of forward motion is considered.

The tube 3 consists of a working material to which the tool 1 that is made of ice and that is formed does not adhere. For example, the tube 3 consists of silicone plastic, or the tube 3 is coated inside with such a working material.

In addition to the cooling coil 5 through which coolant flows, attached to the outside of the tube 3, or instead of the same, cooling can be achieved by using Peltier elements applied to the tube 3 or by blowing cold gas on the tube 3.

Due to the forward motion of the tool 1 in the form of a rod that is made of ice, the consumption of the same by ablation is offset.

Tools 1 in the form of rods that are made of ice of the described type can be used, for example, when sealing insulating glass blanks as pressing elements for the forming of sealing compound introduced into corner areas of an insulating glass blank.

Usually, the edge joint (the latter lies outside of the intermediate space 9 of an insulating glass blank that is bounded by a spacer 10) of an insulating glass blank is filled with sealing compound 11 in such a way that in the corner areas, first a (small) projecting length of sealing compound 11 is present, as is shown diagrammatically in FIG. 2.

The tool used for forming the sealing compound 11 in the corner area can be formed by, for example, the front surfaces of two tools 1 in the form of rods that are made of ice, which together occupy an angle that corresponds to the angle of the corner of the insulating glass blank, as is shown in FIG. 2.

Sealing compound 11 is deformed and pressed in the area of the corner by tools 1 being put on the corner of the insulating glass blank and applied to the corner in the direction of the arrow 8.

A tool 12, comprising two rods 13 that are made of ice, is depicted in an oblique cutaway view in FIG. 3.

Another one-piece embodiment of the tool 12 is shown in FIG. 4. An (angled) support 14 can be assigned to the tool 12 (FIGS. 5 and 6). Common insulating glass elements exclusively have corners with angles of 90

°; insulating glass elements with other (less frequently occurring) shapes can have corners with obtuse or acute angles. Also, for this purpose, the method according to the invention and the device according to the invention are suitable.

In the case of the tools 12 for pressing a corner according to FIGS. 3 and 4, surfaces that are applied on the corners (“pressing surfaces,” “effective surfaces”) are side surfaces 15 from a rod or from several rods that are made of ice, as is shown in FIGS. 3 to 6.

When the pressing surfaces are side surfaces 15 of a tool 12 that consists of one or more rods 13 that are made of ice, there is a danger that the tool 12 may break. A break can be prevented by supports 14 lying flat adjacent to the side surfaces of the tool 12, opposite to the side surfaces 15, as is depicted in FIGS. 5 and 6.

When the pressing surfaces of side surfaces 15 of a tool 12 that consists of one or more rods 13 that are made of ice are formed, it can be provided that the ice—seen in the direction of forward motion 8 (FIG. 1)—is melted off according to the position at which the pressing takes place in order to limit the length of the tool 12 to a practical size. The downsizing of the tool 12 can be done in a controlled manner, and the melting water 16 that is formed can be discharged, collected in a holding tank 17 (FIG. 7).

Thus, it is conceivable to insert the rod 13 (the rods) that is made of ice and that forms the tool 1 or 12 into a heated chamber as a holding tank 17 and to melt it there, as is depicted in FIG. 7. The area 18 of the tool 1, 12 is the area that is available for use as a pressing tool.

Additional embodiments of a tool 12 are depicted in FIGS. 8 and 9. The tool 12 of FIG. 8 consists of a shoe 20 that is manufactured from a rigid, in particular metal, working material and that is provided on the corner of the insulating glass blank for pressing the sealing compound in the area of a corner of an insulating glass blank in the direction of the arrow 21. The surfaces of the tool 12 that are applied to the corner during pressing (“pressing surfaces”) are provided as effective surfaces with a coating 22 that is made of ice.

The angle that the pressing surfaces of the tool 12 with the coating 22 occupy with one another can either be constant, as is shown in FIG. 8, or the shoe 20 consists of two parts, which are connected in a hinged manner to one another in such a way that the angle between the pressing surfaces can be modified, as is shown in FIG. 9.

For clean and smooth execution of a seal in the corner area of an insulating glass blank, the use of small cover and scraping plates is described in, e.g., DE 34 08 688 A1 and in AT 13 328 U.

In practice, the problem frequently occurs that such small cover and scraping plates, which come into contact with sealing compound according to requirements, entrain sealing compound when they are removed again after their use. When such small cover and scraping plates entrain sealing compound, soiling occurs, on the one hand, and it is impossible, on the other hand, to fill the edge joint smoothly and completely with sealing compound.

The entraining of sealing compound is prevented according to the invention by the tools that are used in the form of small cover and scraping plates being provided with a coating that is made of ice at least in the areas (effective surfaces) that come into contact with sealing compound.

In FIGS. 10 to 12, it is depicted how, using a tool 30 in the form of a small cover and scraping plate, it can be ensured that the sealing of the area of the corner in which the sealing of an insulating glass blank is completed can be executed in a clean and smooth manner. The tool 30 in the form of a small cover and scraping plate comprises a basic element 31, which preferably is manufactured from a metal working material, and a coating 32 that is made of ice that is applied on the basic element 31.

In this case, the procedure can be performed as follows:

A sealing nozzle 33 with small nozzle plates 34 is moved along a side edge of the insulating glass blank in the direction of the arrow 35 to the corner, whereby the edge joint on the other side edge, which runs to the corner, is already filled with sealing compound 11. At the end of the other side edge, the small cover and scraping plate 30 has been applied so that its end is essentially flush with the end of the edge of the insulating glass blank, on which the sealing nozzle 33 is moved along (FIG. 10).

The small nozzle plate 34 that is applied to the sealing nozzle 33 is scraped on the tool 30 in the form of the small cover and scraping plate (movement in the direction of the arrow 35), so that the corner area of the edge joint is filled completely with sealing compound 11, without sealing compound 11 being able to spill over (FIG. 11) since the tool 30 in the form of the small cover and scraping plate and the small nozzle plate 34 form a shuttering for the sealing compound in the edge joint in the corner area.

The tool 30 in the form of the small cover and scraping plate is then removed from its operative position in the direction of the arrow 36. Since there is no adhesive interaction between the sealing compound 11 and the small cover and scraping plates based on the coating 32 that is made of ice, the small cover and scraping plate can be removed in any direction without sealing compound 11 adhering to it (FIG. 12).

In FIGS. 10 to 12, a right-angled corner of an insulating glass blank is depicted. In the case of acute-angled or obtuse-angled corners, it is possible to proceed analogously, whereby the side of the small nozzle plate 34 that faces the edge joint and the coating 32 of the small cover and scraping plate that is made of ice are then arranged at an angle to one another that deviates from a right angle.

In FIGS. 13 to 15, it is depicted how it can be ensured, using a tool 30 in the form of the small cover and scraping plate, that even a seal in the area of a corner, which is not the corner in which the sealing of an insulating glass blank is completed, can be executed in a clean and smooth manner. In this case, the tool 30 acts as a small cover plate and comprises a basic element 31, which preferably is manufactured from a metal working material, and a coating 32 that is made of ice and that is applied on the basic element 31.

The tool 30 in the form of a small cover plate and the small nozzle plate 34 that is connected to the sealing nozzle 33 are thus applied on the edge of an insulating glass blank in such a way that they cover the edge joints in the corner area toward the outside (FIG. 13).

Before the sealing nozzle 33 is moved in the direction of the arrow 35 in order to fill the edge joint with sealing compound 11, the corner area of the edge joint is filled completely with sealing compound 11. In this case, the tool 30 in the form of the small cover plate and the small nozzle plate 34 are used as shuttering, which prevents a spilling-over of the sealing compound 11 (FIG. 14).

After the corner area is filled completely with sealing compound 11, the tool 30 in the form of the small cover plate is removed from its active position in the direction of the arrow 36, and the sealing nozzle 33 moves in the direction 35, whereby it fills the next edge joint with sealing compound 11. Since there is no adhesive interaction between the sealing compound 11 and the tool 30 in the form of the small cover plate due to the coating 32 that is made of ice, the small cover plate can be removed in any direction without the sealing compound 11 adhering to it (FIG. 15).

In FIGS. 13 to 15, a right-angled corner of an insulating glass blank is depicted. In the case of acute-angled or obtuse-angled corners, it is possible to proceed analogously, whereby the effective surface of the small nozzle plate 34 that faces the edge joint and the effective surface of the tool 30 in the form of a small cover plate that is covered with ice are then oriented toward one another at an angle that deviates from a right angle.

The small nozzle plate 34 is laid out in such a way that it glides along on the inner edges of the sides of glass panes 40 and 41 (FIG. 16) and in this case completes the edge joint. Typically, the small nozzle plate 34 has a molded glide surface. The sealing nozzle 33 and its small nozzle plates 34 are shown in cross-section in FIG. 16. Sealing compound 11 is fed to the sealing nozzle 33 via at least one feed 38.

Another function of the small nozzle plate 34 consists in smoothly spreading the sealing compound 11 that is introduced into the edge joint.

It is undesirable and disadvantageous when, during the removal of the sealing nozzle 33, sealing compound 11 adheres to the small nozzle plate 34, since otherwise soiling occurs and a clean filled edge joint does not result.

In order to avoid this, it can be provided within the framework of the invention that the small nozzle plate 34 holds a coating 37 that is made of ice on its molded glide surface (effective surface) that comes into contact with the sealing compound 11 (FIG. 17).

Tools that are made of ice or that are provided at least partially with a coating that is made of ice can be used as scrapers for other, possibly soiled, components. In particular, the small nozzle plate 34 that is arranged on a sealing nozzle 33 can be scraped for cleaning purposes on a scraper 50 by moving in the direction 51, as is depicted in FIG. 21. This is useful in particular when the small nozzle plate 34 does not have (according to the invention) anti-adhesive properties, or when sealing compound 11 has been ejected from a sealing nozzle 33 before the sealing of an insulating glass blank, which sealing compound 11 is discarded, so that “aged” sealing compound 11 is not poured into the edge joint of an insulating glass blank.

The forming of a coating 56 that is made of ice on the effective surface of a tool, such as, e.g., the tool 55 that is depicted in FIGS. 18 and 19, can be produced, for example, by a line 57 through which a cooled medium flows, which line 57 can be designed as a cooling coil.

Such a line 57 can be arranged in a tool 55 (FIG. 18) or in a heat-conducting unit on a tool 55 (FIG. 19).

The forming of the coating 56 on the effective surface of the tool 55 can also be produced by cooling the tool 55 by blowing in cold gas (e.g., air) (FIG. 20).

Problems arise during transport and in the case of the intermediate storage of insulating glass elements when the latter are placed on one of their edges before the sealing compound 11 that is introduced into the edge joint is sufficiently hardened, since in this case, it can result in the soiling of the support devices or in the insulating glass elements sticking to the support devices. Also, these problems can be solved when the tools (conveying elements, support elements) that come into contact with the edge area of the insulating glass elements are covered with a layer that is made of ice on the effective surfaces that come into contact with the insulating glass elements.

In addition to the cited examples from the technical field of the sealing of insulating glass blanks, the shaping of a strand of pasty, sticky compound is described as another practical example of the invention.

In FIGS. 22 and 23, a bead 62 that consists of pasty, sticky material and is laid down on a component 61 and a molded element 63 are depicted. The molded element 63 is pressed onto the bead 62 and is run along the latter in order to give a desired (for example a square, in FIG. 24) cross-sectional shape to the bead 62 that is laid down on the component 61. At least the parts of the molded element 63 that come into contact with the bead 62 that consists of a pasty and sticky compound, i.e., its effective surfaces, are covered with a layer of ice 64.

A molded element 63 can also be used to provide a specific cross-sectional shape to a bead 62 that is applied on the edge of a flat component (FIG. 24).

Thus, FIG. 24 depicts how using a molded element 63 whose effective surfaces are covered with a layer of ice 64, a design that consists of several layers 65, 66, 67, is provided with an edge cover that consists of a pasty, sticky compound 62. This layer design can be, for example, a photovoltaic module.

A tool can be covered with a coating that is made of ice by being cooled to a temperature that lies below the freezing point of water and by being brought into contact with liquid water or water vapor.

To form a layer of ice on a tool, the cooled tool can be immersed in water.

To form a layer of ice on a tool, the cooled tool can be flushed with water.

To form a layer of ice on a tool, the cooled tool can be sprayed with water.

To form a layer of ice on a tool, the cooled tool can be drizzled with water.

To form a layer of ice on a tool, the cooled tool can be exposed to an aerosol that consists of water in air (“mist”).

To form a layer of ice on a tool, it may be sufficient to expose the cooled tool to the ambient air when the atmospheric humidity of the ambient air is high enough.

To form a layer of ice on a tool, the cooled tool can be exposed to water-concentrated air, in particular water-saturated air.

For cooling the tool that is to be provided with a coating that is made of ice, known measures are available. For example, a cooling loop or coil can be arranged in the interior (FIG. 18) or on a surface of the tool that is not to be coated with ice (FIG. 19), or the tool is designed to be hollow and coolant flows through it. A cooling coil can be replaced by one or more Peltier elements. Furthermore, it is taken into consideration that a stream of cold gas is blown on the tool (FIG. 20).

It is advantageous when the tool that is to be cooled at least in the area of its effective surface consists of a material with high heat conductivity, in particular a metal working material.

In summary, the method can be described as follows:

During the processing of pasty, sticky material 11, 62, a tool 1, 12, 30, 33, 55, 63 is used, which consists of a working material that can be melted or sublimated, in particular ice, at least in the areas that come into contact with the material 11, 62 that is to be processed.

1. Method for processing sticky materials (11, 62), in particular deformable sticky materials, characterized in that a tool (1, 12, 30, 33, 55, 63) is used that consists of a working material at least on its effective surface that engages on the material (11, 62) that is to be processed, which working material that under the conditions prevailing during the processing, in particular the temperature, changes its first solid aggregate state.

2. Method according to claim 1, wherein the working material of the tool (1, 12, 30, 33, 55, 63) melts.

3. Method according to claim 1, wherein the working material of the tool (1, 12, 30, 33, 55, 63) is sublimated.

4. Method according to claim 1, wherein the effective surface is produced by a coating (22, 32, 37, 65, 64) being produced in the area of the tool (12, 30, 33, 55, 63), which comes into contact with the material that is to be processed.

5. Method according to claim 4, wherein the coating (22, 32, 37, 56, 64) is produced by the tool (12, 30, 33, 55, 63) being cooled and flushed and/or sprayed and/or drizzled with the working material.

6. Method according to claim 1, wherein a tool (12, 30, 33, 55, 63) is used that at least in its part that holds the coating (22, 32, 37, 56, 64) consists of a working material with a high heat conductivity, such as metal.

7. Method according to claim 1, wherein a tool (1, 12, 30, 33, 55, 63) is used whose working material that forms the effective surface is frozen water.

8. Method according to claim 1, wherein a tool (1, 12, 30, 33, 55, 63) is used that is designed as a spatula tool, a scraping tool (30), a smoothing tool, a smoothing roller, a sealing nozzle (33), a conveying element or a shuttering element.

9. Method according to claim 1, wherein a tool (1, 12, 30, 33, 55, 63) is used of which the working material that forms the effective surface of the tool (1, 12, 30, 33, 55, 63) is renewed continuously.

10. Method according to claim 1, wherein a tool (1, 12) is used with two effective surfaces (15) that are at angles to one another.

11. Method according to claim 1, wherein a tool that is designed as a sealing nozzle (33) with a small sealing plate (34) is used and wherein the surface of the small nozzle plate (34) that faces the edge joint is covered with the coating (32), in particular made of ice, as an effective surface.

12. Method according to claim 1, wherein the tool (1, 12, 30, 33, 55, 63) is cleaned by its being heated in order to produce a melting/sublimating of the working material.

13. Tool, in particular tool (1, 12, 30, 33, 55, 63) for processing deformable, in particular sticky, working material (11, 62), preferably for use during execution of the method according to claim 1, wherein the tool (1, 12, 30, 33, 55, 63) consists of a substance that can be melted or sublimated at least in the area or the areas that come into contact with the material (11, 62) that is to be processed.

14. Tool according to claim 13, wherein the working material of the tool (1, 12, 30, 33, 55, 63) has a melting point that is less than or equal to the temperature that prevails during processing.

15. Tool according to claim 13, wherein the working material at the temperature that prevails during the processing is sublimated.
